(19) United States
(12) Patent Application Publication
(10) Pub. No.: US 2024/0422293 A1
(43) Pub. Date: Dec. 19, 2024

(54) System and Method for Determining the Status of a Component of an Installation

(71) Applicant: Siemens Aktiengesellschaft, München (DE)

(72) Inventors: Holger Schönherr, Feucht (DE); Claudio Laloni, Taufkirchen (DE)

(73) Assignee: Siemens Aktiengesellschaft, München (DE)

(21) Appl. No.: 18/702,213

(22) PCT Filed: Sep. 30, 2022
(86) PCT No.: PCT/EP2022/077285

§ 371 Date: Apr. 17, 2024

(30) Foreign Application Priority Data
Oct. 20, 2021 (DE) 10 2021 211 849.6

(51) Int. Cl. H04N 7/18; G06V 20/52

(52) U.S. Cl. CPC H04N 7/181; G06V 20/52

(57) ABSTRACT

Various embodiments of the teachings herein include a system for monitoring states ZSTAT_i of a number NSIG≥1 of state signal transmitters ZSIG_1 with i=1, . . . , NSIG of one or more components in surroundings of an installation, a respective state signal transmitter ZSIG_i configured to transmit a signal S_i that unambiguously represents its current state ZSTAT_i. An example system includes: a recording subsystem comprises a number NERF≥1 of recording units KAM_k with k=1, . . . , NKAM, a respective recording unit KAM_k configured to record the transmitted signals S_i; and an analysis subsystem configured to automatically use the signals S_i thus captured to derive current states ZSTAT_i of the respective state signal transmitters ZSIG_i.

### CROSS-REFERENCE TO RELATED APPLICATIONS

This application is a U.S. National Stage Application of International Application No. PCT/EP2022/077285 filed Sep. 30, 2022, which designates the United States of America, and claims priority to DE Application No. 10 2021 211 849.6 filed Oct. 20, 2021, the contents of which are hereby incorporated by reference in their entirety.

### TECHNICAL FIELD

The teachings of the present disclosure relate to installations. Various embodiments include methods and/or system for recording an operating state of a component, for example a machine, of an installation.

### BACKGROUND

For efficient and reliable operation of an installation, for example an industrial installation, that performs an industrial process, for example to manufacture a product or the like, it is of essential importance that the operating states of the components of the industrial installation that are involved in the process, for example the machines of said industrial installation and other systems, are known in order to be able to react to unscheduled divergences from normal states with suitable measures. Accordingly, the operating states of the individual components are continuously monitored. The individual results of the monitoring operations are frequently signaled by way of individual state signal transmitters positioned on or in immediate proximity to the respective component, said state signal transmitters being in the form of traffic-light-like signal columns, for example, that generate optical signals whose color depends on the current operating state of the associated component. These visible signals are visually inspected at regular or irregular intervals by an operator of the component or the industrial installation, for example, in order to obtain an impression of the operating state and to react if necessary. This visual inspection is generally time-consuming and moreover cannot guarantee that a fault is reacted to quickly enough. This situation becomes increasingly problematic as the complexity of an industrial installation increases, because the effort for visual monitoring becomes greater and in some cases can no longer be provided and integrating the individual signals from the components into a supervisory system of the industrial installation is often associated with great effort.

### SUMMARY

Teachings of the present disclosure provide improved systems and/or methods for recording the operating states of the components of an industrial installation. For example, some embodiments include a system for monitoring states ZSTAT_i of a number NSIG≥1 of state signal transmitters ZSIG_1 with i=1, . . . , NSIG of one or more components (110, 120, 130) in surroundings UM of an installation, a respective state signal transmitter ZSIG_i being configured to transmit a signal S_i that unambiguously represents its current state ZSTAT_i, characterized by a recording subsystem (141) and an analysis subsystem (142), wherein the recording subsystem (141) comprises a number NERF≥1 of recording units KAM_k with k=1, . . . , NKAM, a respective recording unit KAM_k being configured to record the transmitted signals S_i, and the analysis subsystem (142) is configured to automatically use the signals S_i thus captured to derive the current states ZSTAT_i of the respective state signal transmitters ZSIG_i.

In some embodiments, the current state ZSTAT_i of a respective state signal transmitter ZSIG_i represents the current operating state STAT_i of a component i of the installation that is associated with the respective state signal transmitter ZSIG_i, a respective state signal transmitter ZSIG_i being configured to adjust a value x_i=f(STAT_i) of a predefined, variable signal parameter SIGPARA of the signal S_i that unambiguously represents its current state ZSTAT_i in accordance with the current state ZSTAT_i.

In some embodiments, the system is designed to produce a representation IMA_k of the signals S_i by recording the signals S_i and to determine in a respective representation IMA_k, for each signal S_i represented in said representation, a value x_i of a predefined, variable signal parameter SIGPARA of the respective signal S_i, and to use the respective determined value x_i to derive the current state ZSTAT_i of the related state signal transmitter ZSIG_i.

In some embodiments, the signals S_i are electromagnetic, in particular optical, signals, characterized in that the recording units KAM_k are in the form of cameras and the representations IMA_k produced by the cameras KAM_k are images IMA_k, a respective camera KAM_k being able to be used to depict at least one of the signals S_i in a respective image IMA_k, and the analysis subsystem (142) is configured to perform an analysis method for a respective image IMA_k, the analysis method being used to determine in a respective image IMA_k, for each signal S_i depicted in said image, a value x_i of a predefined, variable signal parameter SIGPARA of the respective identified signal S_i and to use the respective determined value x_i to derive the current state ZSTAT_i of the related state signal transmitter ZSIG_i.

In some embodiments, the image IMA_k is a dynamic image.

In some embodiments, the image IMA_k is a static image, the system being configured to produce a multiplicity of static images IMA_k at predefined intervals of time dTIMA or to produce a respective static image IMA_k when so required by a user, and to perform the analysis method for a respective static image IMA_k produced.

In some embodiments, the analysis subsystem (142) is configured to use a position P(S_i) of a depiction of the respective signal S_i in the respective image IMA_k to identify the state signal transmitter ZSIG_i related to the signal S_i and to unambiguously associate a respective derived state ZSTAT_i with the related state signal transmitter ZSIG_i thus identified.

In some embodiments, the system is configured to perform an initialization method INI in which a recording step REC comprises using a respective camera KAM_k to capture at least one image IMA_k that depicts, for each state signal transmitter situated in the recording range FoV_k of the camera KAM_k, the signal S_i delivered by this state signal transmitter ZSIG_i, a detection step DET comprises detecting in a respective captured image IMA_k the positions P(S_i) of the depictions of the signals S_i that are thus generated in the image IMA_k, an identification step IDENT comprises taking the detected positions P(S_i) as a basis for specifying sections IMA_k_i in the respective image IMA_k that correspond to the state signal transmitters ZSIG_i, and a step DATA comprises recording the state signal transmitter ZSIG_i to which the respective section IMA_k_i corresponds in a database DAT.

In some embodiments, the system in the form of a retrofit system for the installation.

As another example, some embodiments include a method for monitoring states ZSTAT_i of a number NSIG≥1 of state signal transmitters ZSIG_1 with i=1, . . . , NSIG of one or more components (110, 120, 130) in surroundings UM of an installation, a respective state signal transmitter ZSIG_i being configured to transmit a signal S_i that unambiguously represents its current state ZSTAT_i, characterized in that the transmitted signals S_i are recorded using recording units KAM_k with k=1, . . . , NKAM of a recording subsystem (141), and an analysis subsystem (142) is used to automatically derive the current states ZSTAT_i of the respective state signal transmitters ZSIG_i from the recorded signals S_i.

In some embodiments, a respective representation IMA_k of the signals S_i is produced by recording the signals S_i by means of the recording units KAM_k, in a respective representation IMA_k, for each signal S_i represented in said representation, a value x_i of a predefined, variable signal parameter SIGPARA of the respective signal S_i is determined, and the respective determined value x_i is used to derive the current state ZSTAT_i of the related state signal transmitter ZSIG_i.

In some embodiments, the signals S_i are electromagnetic, in particular optical, signals, characterized in that the representations IMA_k of the signals S_i are images IMA_k in which the signals S_i are depicted in corresponding regions of the respective image IMA_k, wherein an analysis method comprises determining in a respective image IMA_k, for each signal S_i depicted in said image, a value x_i of a predefined, variable signal parameter SIGPARA of the respective identified signal S_i and using the respective determined value x_i to derive the current state ZSTAT_i of the related state signal transmitter ZSIG_i.

In some embodiments, a position P(S_i) of a depiction of the respective signal S_i in the respective image IMA_k is used to identify the state signal transmitter ZSIG_i related to the signal S_i and to unambiguously associate a respective derived state ZSTAT_i with the related state signal transmitter ZSIG_i thus identified.

In some embodiments, the state signal transmitter ZSIG_i related to the signal S_i is identified by establishing which section IMA_k_i from previously specified sections IMA_k_i of the image IMA_k contains the depiction of the signal S_i, wherein a database DAT stores the state signal transmitter ZSIG_i to which a respective section IMA_k_i corresponds.

In some embodiments, in an initialization method INI, in particular prior to the states ZSTAT_i being monitored, a recording step REC comprises using a respective camera KAM_k to capture at least one image IMA_k that depicts, for each state signal transmitter situated in the recording range FoV_k of the camera KAM_k, the signal S_i delivered by this state signal transmitter ZSIG_i, a detection step DET comprises detecting in a respective captured image IMA_k the positions P(S_i) of the depictions of the signals S_i that are thus generated in the image IMA_k, an identification step IDENT comprises taking the detected positions P(S_i) as a basis for specifying sections IMA_k_i in the respective image IMA_k that correspond to the state signal transmitters ZSIG_i, and a step DATA comprises recording the state signal transmitter ZSIG_i to which the respective section IMA_k_i corresponds in a database DAT.

### BRIEF DESCRIPTION OF THE DRAWINGS

Illustrative embodiments of the teachings herein are explained more thoroughly below with reference to drawings. In these drawings, identical components are denoted by identical reference signs in different figures if necessary. It is therefore possible for the description of a second figure to involve no further explanations regarding a specific reference sign that has already been explained in connection with another, first figure. In such a case, that the component denoted by this reference sign in said second figure also has the same properties and functionalities as explained in connection with the first figure, without more detailed information in connection with the second figure. Moreover, for the sake of clarity, sometimes not all reference signs are shown in all figures, but rather only those to which reference is made in the description of the respective figure. In the drawings:

FIG. 1 shows an industrial installation incorporating teachings of the present disclosure;

FIG. 2 shows an image IMA_1 produced by a first camera KAM_1 incorporating teachings of the present disclosure;

FIG. 3 shows an image IMA_2 produced by a second camera KAM_2 incorporating teachings of the present disclosure;

FIG. 4 shows the sequence of a first example monitoring method incorporating teachings of the present disclosure;

FIG. 5 shows the sequence of a second example of the monitoring method incorporating teachings of the present disclosure; and

FIG. 6 shows the sequence of an initialization incorporating teachings of the present disclosure.

### DETAILED DESCRIPTION

In the description herein, an industrial installation has a multiplicity of components i or machines with state signal transmitters ZSIG_i. A respective component i and at least one state signal transmitter ZSIG_i are associated with one another and the respective state signal transmitter ZSIG_i is configured to provide a signal that unambiguously represents an operating state STAT_i of the associated component i. For this purpose, the respective state signal transmitter ZSIG_i is configured to transmit a signal S_i that unambiguously represents its own current state ZSTAT_i, but its own current state ZSTAT_i represented by the signal S_i is directly and unambiguously dependent on the operating state STAT_i of its associated component i, i.e. ZSTAT_i=STAT_i, and so the signal S_i simultaneously represents the operating state of the component i.

Some embodiments of the teachings herein include a system for monitoring states ZSTAT_i of a number NSIG≥1 of state signal transmitters ZSIG_1 with i=1, . . . , NSIG of one or more components in surroundings UM of the industrial installation. The system comprises a recording subsystem and an analysis subsystem, the recording subsystem comprising a number NERF≥1 of recording units KAM_k with k=1, . . . , NKAM, a respective recording unit KAM_k being arranged and configured to record the transmitted signals S_i. The analysis subsystem is configured to automatically use the signals S_i thus captured to derive the current states ZSTAT_i of the respective state signal transmitters ZSIG_i, which, as already mentioned, correspond to the operating states STAT_i of the components or machines.

The current state ZSTAT_i of a respective state signal transmitter ZSIG_i represents the current operating state STAT_i of the associated component i. Monitoring and analysis of the state signal transmitters is therefore used to directly record the operating state of the respective component. A respective state signal transmitter ZSIG_i is configured to adjust a value x_i=f(STAT_i) of a predefined, variable signal parameter SIGPARA of the signal S_i that unambiguously represents its current state ZSTAT_i in accordance with the current state ZSTAT_i. In other words and in more general terms, different operating states STAT_i are represented by signals S_i that have certain signal parameters SIGPARA1, SIGPARA2, . . . , for example wavelength or color or signal intensity, etc. In order to express different operating states, the value x_i of at least one of these signal parameters SIGPARAp is varied and, depending on the operating state to be conveyed, differently adjusted, i.e. the value x_i is a function of the instantaneous state ZSTAT_i, i.e. x_i=f(ZSTAT_1).

The system may be designed to produce a representation IMA_k of the signals S_i by recording the signals S_i. The analysis subsystem is configured to identify or locate in a respective representation IMA_k each signal S_i represented in said representation, to determine for each identified signal S_i a value x_i of a predefined, variable signal parameter SIGPARA of the respective signal S_i and to use the respective determined value x_i to derive the current state ZSTAT_i of the related state signal transmitter ZSIG_i.

The signals S_i may be electromagnetic, in particular optical, signals, for example. The recording units KAM_k are then in the form of cameras and the representations IMA_k of the signals S_i that are produced by the cameras KAM_k are two-dimensional images IMA_k. A respective camera KAM_k can be used to depict at least one of the signals S_i in a respective image IMA_k. To this end, the cameras KAM_k are arranged and configured such that they each produce an image IMA_k of their surroundings UM that depicts the at least one signal S_i or in which the at least one signal S_i is discernible. The analysis subsystem is configured to perform an analysis method for a respective image IMA_k, the analysis method being used to identify or locate in a respective image IMA_k each signal S_i depicted in said image, to determine for each identified signal S_i a value x_i of a predefined, variable signal parameter SIGPARA of the respective identified signal S_i and to use the respective determined value x_i to derive the current state ZSTAT_i of the related state signal transmitter ZSIG_i, for example on the basis of an applicable database DAT in which the possible values x_i are unambiguously associated with the possible operating states ZSTAT_i.

In this design with optical signals S_i, the variable signal parameter SIGPARA may be the color or the wavelength or the spectral range of the optical signal S_i, for example. A value x_i may then be “green”, “amber”, “red”, combinations of these or any other suitable color, for example. Changing, e.g. flashing, signals are also possible or the position of a light source is altered depending on the state.

An image IMA_k may be a dynamic image, e.g. a video, or else a static image. In the latter case, the system is configured to produce a multiplicity of static images at predefined intervals of time dTIMA or to produce a respective static image when so prompted by a user. The analysis method is then performed for a respective static image IMA_k produced.

The analysis subsystem may be configured to use a position P(S_i) of a depiction of the respective signal S_i in the respective image IMA_k to identify the state signal transmitter ZSIG_i related to the signal S_i, i.e. the state signal transmitter that transmits the respective signal S_i, and to unambiguously associate a respective derived state ZSTAT_i with the related state signal transmitter ZSIG_i thus identified and therefore the corresponding component.

The system may moreover be configured to perform an automatic or at least semiautomatic initialization method INI in which a recording step REC comprises using a respective camera KAM_k to capture at least one image IMA_k that depicts, for each state signal transmitter situated in the undisturbed, i.e. not concealed by walls or other obstacles, recording range FoV_k of the camera KAM_k, the signal S_i delivered by this state signal transmitter ZSIG_i. A detection step DET comprises detecting in a respective captured image IMA_k the positions P(S_i) of the depictions of the signals S_i that are thus generated in the image IMA_k, it being unimportant what value a respective signal parameter of such a signal S_i has, but rather the position P(S_i) of the depiction of the respective signal S_i in the image IMA_k being determined. An identification step IDENT comprises taking the detected positions P(S_i) as a basis for specifying or defining sections IMA_k_i in the respective image IMA_k that correspond to the state signal transmitters ZSIG_i and therefore the components i. The sections IMA_k_i can be identified for example on the basis of an artificial intelligence implemented in the analysis subsystem or else manually. A concluding step DATA comprises recording the state signal transmitter ZSIG_i or component i to which the respective section IMA_k_i corresponds in a database DAT. This can be accomplished for example by way of a manual input from a user U who knows which state signal transmitter ZSIG_i is visible in a respective section IMA_k_i. As an alternative to manual input, it is also possible at this juncture for ZSIG_i and IMA_k_i to be associated automatically, as explained below.

In some embodiments, the system is in the form of a retrofit system for the installation. That is to say that it can readily be integrated into an existing installation with existing components and with existing state signal transmitters without needing to take action in the installation per se. The presented initialization method permits the retrofit system to be matched to the circumstances of the installation largely automatically.

A corresponding method for monitoring states ZSTAT_i of the state signal transmitters ZSIG_1 comprises recording the signals S_i transmitted by the state signal transmitters ZSIG_i using recording units KAM_k with k=1, . . . , NKAM of a recording subsystem (141). The analysis subsystem is used to automatically derive the current states ZSTAT_i of the respective state signal transmitters ZSIG_i from the recorded signals S_i.

A respective representation IMA_k of the signals S_i can be produced by recording the signals S_i by means of the recording units KAM_k. In a respective representation IMA_k, for each signal S_i represented in said representation, a value x_i of a predefined, variable signal parameter SIGPARA of the respective signal S_i is determined, and the respective determined value x_i is used to derive the current state ZSTAT_i of the related state signal transmitter ZSIG_i, for example on the basis of a database in which values x_i and states ZSTAT_i are unambiguously associated with one another.

The signals S_i may be electromagnetic, in particular optical, signals. In that case, the representations IMA_k of the signals S_i that are produced by the recording units KAM_k are for example two-dimensional images IMA_k in which the signals S_i are depicted in applicable regions or pixel ranges of the respective image IMA_k. An analysis method comprises identifying or locating in a respective image IMA_k each signal S_i depicted in said image. For each identified signal S_i, a value x_i of a predefined, variable signal parameter SIGPARA of the respective identified signal S_i is determined and the respective determined value x_i is used to derive the current state ZSTAT_i of the related state signal transmitter ZSIG_i, for example on the basis of the aforementioned database.

A position (P Si) of a depiction of the respective signal S_i in the respective image IMA_k can be used to identify the state signal transmitter ZSIG_i related to the signal S_i, i.e. the state signal transmitter that transmits the respective signal S_i, and therefore the corresponding component. A respective state ZSTAT_i derived from the value x_i of the signal parameter SIGPARA of the respective identified signal S_i is then unambiguously associated with the related state signal transmitter ZSIG_i thus identified and therefore the corresponding component i.

The state signal transmitter ZSIG_i related to the signal S_i, i.e. the state signal transmitter ZSIG_i that transmits the respective signal S_i, can be identified by establishing which section IMA_k_i from previously specified sections IMA_k_i of the image IMA_k contains the depiction of the signal S_i, wherein a database DAT stores the state signal transmitter ZSIG_i or component i to which a respective section IMA_k_i corresponds.

An initialization method INI, which may be performed before the states ZSTAT_i are actually monitored, can comprise the recording step REC, the detection step DET, the identification step IDENT and the concluding step DATA, as already introduced.

In summary, the teachings of the present disclosure may be used for automatic monitoring of operating states STAT_i of one or more machines in an industrial installation. The machines are equipped with state signal transmitters ZSIG_i that transmit signals S_i representing the states STAT_i of the respective associated machines. The signals S_i are recorded by appropriate recording units, for example cameras, and automatically analyzed with regard to the represented operating states in an analysis subsystem. The analysis results are automatically associated with the related state signal transmitters and therefore the corresponding machines, and so a superordinate supervisory system can react to the detected operating states by initiating any measures.

Other advantages and embodiments are evident from the drawings and the corresponding description.

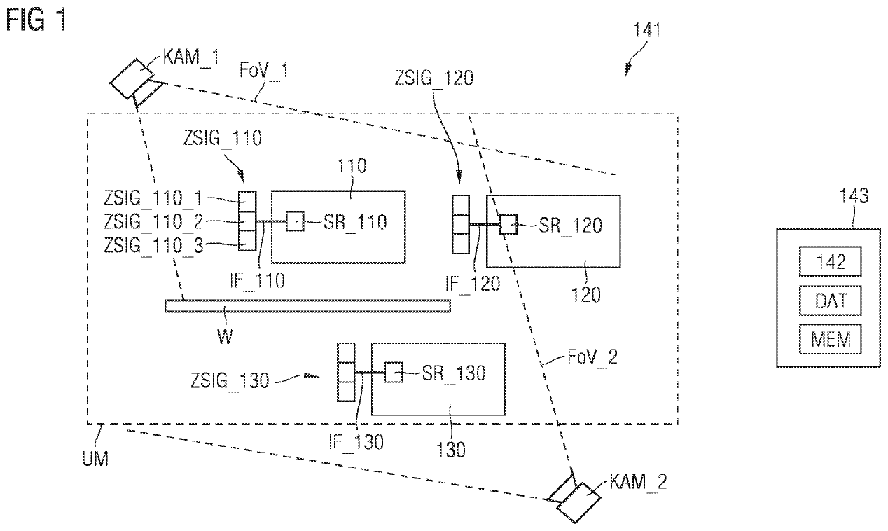

FIG. 1 shows an industrial installation 100, which may be in the form of a fabrication or production installation for manufacturing a product, for example, by way of example and in simplified form. Surroundings UM of the industrial installation 100 contain a multiplicity of components of the industrial installation, only three components 110, 120, 130 being shown in FIG. 1 for the sake of clarity. By way of example, the components may be the machines and/or systems needed in order to fulfil the purpose of the industrial installation 100.

A respective component 110, 120, 130 may be in different operating states STAT_110, STAT_120, STAT_130 during operation of the industrial installation 100, there being able to be two or perhaps more different operating states STAT_110, STAT_120, STAT_130 for a respective component 110, 120, 130, for example depending on the complexity of the individual component 110, 120, 130 and/or perhaps depending on the complexity and form of the process performed by the industrial installation 100. Each of the operating states STAT_110, STAT_120, STAT_130 can assume different values, for example “normal state”, “overload”, “fault state”, “switched off”, “warning”, “standby”, etc., the operating states available for a respective component 110, 120, 130 in turn being dependent on the form or type of the component 110, 120, 130 in question. There may thus possibly be a choice of different numbers and types of operating states for components 110, 120, 130 of different type.

The current operating states of the components 110, 120, 130 are of essential importance for reliable open-loop and closed-loop control of the industrial installation 100. For this reason, the current operating states STAT_110, STAT_120, STAT_130 of all components 110, 120, 130 in a supervisory system 140 of the industrial installation 100 are determined, meaning that the supervisory system 140 can carry out open-loop or closed-loop control of the industrial installation 100 using a control computer 143 of the supervisory system 140 on the basis of the current operating states STAT_110, STAT_120, STAT_130 of the components 110, 120, 130. For example, the supervisory system 140 can comprise the functions of a “manufacturing execution system” (MES) and permit management, guidance, open-loop control and/or supervision of the process performed by the industrial installation, for example the product manufacture mentioned, by coupling to the components 110, 120, 130 of the industrial installation 100. A prerequisite for this is the availability of various data, which can include, among other things, the operating states STAT_110, STAT_120, STAT_130 addressed here.

For example, if one of the components 110, 120, 130 is in the operating state “fault state”, the supervisory system 140 can cause the process taking place in the industrial installation 100 to stop entirely or in part. It is also possible, if one of the components 110, 120 130 is in the operating state “overload” or “warning”, for the supervisory system 140 to cause the process taking place to slow down. Such and also other measures that can be prompted by the supervisory system 140 for the respective operating states STAT_110, STAT_120, STAT_130 and combinations of operating states STAT_110, STAT_120, STAT_130 are typically specified in advance, but may possibly also be predefined spontaneously by an operator of the supervisory system 140, for example if a hitherto unknown combination of STAT_110, STAT_120, STAT_130 is available. In one conceivable development, an artificial intelligence implemented in the supervisory system 140 can specify the measure to be prompted, in particular for such a situation involving an unprecedented combination of operating states STAT_110, STAT_120, STAT_130.

To supply the supervisory system 140 with the current operating states STAT_110, STAT_120, STAT_130 of the components 110, 120, 130, each of the components 110, 120, 130 is equipped with a state signal transmitter ZSIG_110, ZSIG_120, ZSIG_130, a component 110, 120, 130 and a state signal transmitter ZSIG_110, ZSIG_120, ZSIG_130 being respectively unambiguously associated with one another. It is entirely conceivable for a respective state signal transmitter ZSIG_i to be an integral part of the component i. Alternatively, the state signal transmitter ZSIG_i may also be an added or retrofitted part. A respective state signal transmitter ZSIG_i with i=110,120,130 is configured to transmit a signal S_i that unambiguously represents its current state ZSTAT_i. Its current state ZSTAT_i represented by the signal S_i is directly and unambiguously dependent on the operating state STAT_i of its associated component i. Consequently, the current state ZSTAT_i of the state signal transmitter ZSIG_i corresponds to the current state STAT_i of its associated component i, i.e. ZSTAT_i=STAT_i, and the signal S_i transmitted by the state signal transmitter ZSIG_i therefore represents the operating state STAT_i of the component i associated with this state signal transmitter ZSIG_i. To implement this, a respective state signal transmitter ZSIG_i is coupled to the respective component i to be monitored via an interface IF_i that can be used to transmit the state STAT_i of the component i to the state signal transmitter ZSIG_i. The respective current operating state STAT_i of the component i is transmitted from an open-loop and/or closed-loop control unit SR_i of the component i to the respective associated state signal transmitter ZSIG_i via the interface IF_i, and the state signal transmitter ZSIG_i is configured to generate and transmit the signal S_i that represents the state STAT_i.

Accordingly, a respective state signal transmitter ZSIG_i is configured to provide a signal S_i that unambiguously represents the operating state STAT_i of the respective associated component i. For example the state signal transmitter ZSIG_110 thus transmits a signal S_110 that unambiguously represents the operating state STAT_110 of the component 110.

Various realizations of the state signal transmitters ZSIG_i are conceivable. For example, the state signal transmitters ZSIG_i can be realized as signal columns. Such a signal column ZSIG_i has a multiplicity J of optical signal elements ZSIG_i_j with j=1, . . . , J that can generate light signals of different wavelengths or colors similarly to a set of traffic lights, for example, so that a light signal generated in this way is the signal S_i to be transmitted by the state signal transmitter ZSIG_i. FIG. 1 shows such a form of the state signal transmitters ZSIG_i as signal columns with in each case three optical signal elements ZSIG_i_j with j=1, . . . , 3. For the sake of clarity, in FIG. 1 all of the optical signal elements ZSIG_110_1, ZSIG_110_2, ZSIG_110_3 are provided with reference signs only for the state signal transmitter ZSIG_110. For example, the signal element ZSIG_110_1 of the state signal transmitter ZSIG_110 of the component 110 can generate a green light signal, the signal element ZSIG_110_2 can generate an amber light signal and the signal element ZSIG_110_3 can generate a red light signal. In this case the green light signal can stand for “normal state”, the amber light signal can stand for “warning” and the red light signal can stand for “fault state”.

The respective operating state STAT_i of a component i associated with a respective state signal transmitter ZSIG_i can now be signaled to the supervisory system 140 by virtue of, depending on the operating state STAT_i of the component i, a specific one of the optical signal elements ZSIG_i_j, for example ZSIG_i_1, being activated while the other signal elements, that is to say ZSIG_i_2 and ZSIG_i_3 in the cited example, remain deactivated. Depending on which signal element ZSIG_110_j is activated, the transmitted signal S_110 of the state signal transmitter ZSIG_110 that is generated by the activated signal element has a different color and therefore communicates a different meaning.

The state signal transmitters ZSIG_120, ZSIG_130 of the other components 120, 130 may be designed just like the state signal transmitter ZSIG_110 or may be of a different design, depending on which operating states these components 120, 130 can adopt. It is subsequently assumed that the state signal transmitters ZSIG_120, ZSIG_130 are likewise in the form of signal columns having optical signal elements ZSIG_120_j and ZSIG_130_j in different colors, again with j=1, . . . , J and J=3, for example. However, it will be noted at this juncture already that, in general, other numbers J of signal elements are also conceivable and that the selection of the colors of the light signals that can be transmitted by the signal elements and that form the signals S_i can be varied and does not necessarily have to include red, amber and/or green. In general, all state signal transmitters ZSIG_i may thus be in the form of signal columns, but certainly have an arbitrary number J≥1 of optical signal elements ZSIG_i_j that can comprise the aforementioned colors, for example, or else other colors.

In order to record the signals S_i transmitted by the state signal transmitters ZSIG_i, the supervisory system 140 is connected to a recording subsystem 141. This, for its part, comprises a number NKAM≥1 of recording units KAM_k with k=1, . . . , NKAM. In the case of the recording subsystem 141 shown by way of example and in simplified form in FIG. 1, it holds that NKAM=2, i.e. there is provision for two recording units KAM_1, KAM_2.

The recording units KAM_k may be in the form of cameras, for example, which, in the embodiment presented here, are configured in particular such that they can detect the optical signals S_i transmitted by the state signal transmitters ZSIG_i and can depict them in applicable images IMA_k of the surroundings UM. The cameras KAM_k produce the images IMA_k of the surroundings UM that contain the components i and in particular the state signal transmitters ZSIG_i thereof, at least the signals S_i in the images IMA_k produced being visible and distinguishable with regard to their color and possibly on the basis of other signal parameters. Accordingly, the configurations of the cameras KAM_k can be chosen in terms of optical systems and image capture parameters used, for example. The cameras KAM_k are positioned in space such that each of the state signal transmitters ZSIG_i and therefore each signal S_i is in at least one recording range or field of view FoV_k of at least one camera KAM_k, so that each signal S_i is depicted in at least one image IMA_k from one of the cameras KAM_k. In the simplest case, it may suffice to use only one camera KAM_1 if it can be positioned and oriented such that the signals S_i of all relevant signal transmitters ZSIG_1 are recorded. In the situation depicted in FIG. 1, however, the field of view FoV_1 of the camera KAM_1 is disturbed by a wall W, and so the image IMA_1 produced by the camera KAM_1 cannot contain the state signal transmitter ZSIG_130 of the component 130 or the signal S_130 thereof, but rather only the state signal transmitters ZSIG_110, ZSIG_120 of the components 110, 120. There is therefore provision for the other camera KAM_2, which, by way of example, is arranged such that its field of view FoV_2 covers the state signal transmitters ZSIG_120, ZSIG_130 of the components 120, 130 so that the signals S_120, S_130 thereof can be received by KAM_2 and depicted in the image IMA_2 produced by the camera KAM_2. The totality of the images IMA_1, IMA_2 thus reproduces all of the signals S_110, S_120, S_130, with S_120 even being depicted in both images IMA_1, IMA_2.

The images IMA_1, IMA_2 thus produced are analyzed in the supervisory system 140 with regard to the transmitted signals S_i depicted in the images IMA_k in order to determine the sought operating states STAT_i. To this end, the supervisory system 140 is connected to an analysis subsystem 142, or an analysis subsystem 142 can be integrated into or connected to the applicable software of the supervisory system 140. The analysis subsystem 142 may thus be realized in particular as a computer-implemented method in the form of a piece of software, or provided as an appropriate module compatible with the supervisory system 140. In this instance, the analysis subsystem 142 or the software may be implemented centrally on the control computer 143 of the supervisory system 140, for example, the analysis steps that are to be performed to produce the analysis result and are explained below being performed after the cameras KAM_k have transferred the images IMA_k produced to the analysis subsystem 142, or to the central control computer 143. In some embodiments, the analysis subsystem 142 may be realized in a manner distributed over the cameras KAM_k such that the analysis steps to be performed are performed locally in the cameras KAM_k themselves and at the minimum the cameras KAM_k consequently hand over only the respective analysis result to the control computer 143, but not necessarily the individual image IMA_k. Although this requires more complex cameras KAM_k, the data traffic can be substantially reduced, since at the minimum a respective camera KAM_k hands over only information ID_i that unambiguously identifies the relevant component i and also the applicable determined operating state STAT_i to the control computer 143.

In any case, the analysis subsystem 142 produces the analysis result, consisting of the identification ID_i of the component i and the applicable operating state STAT_i, for the images IMA_k in a monitoring method, for example using digital image processing, by carrying out an analysis of the images IMA_k, be it centrally on the control computer 143 or else in a manner locally distributed over the cameras IMA_k.

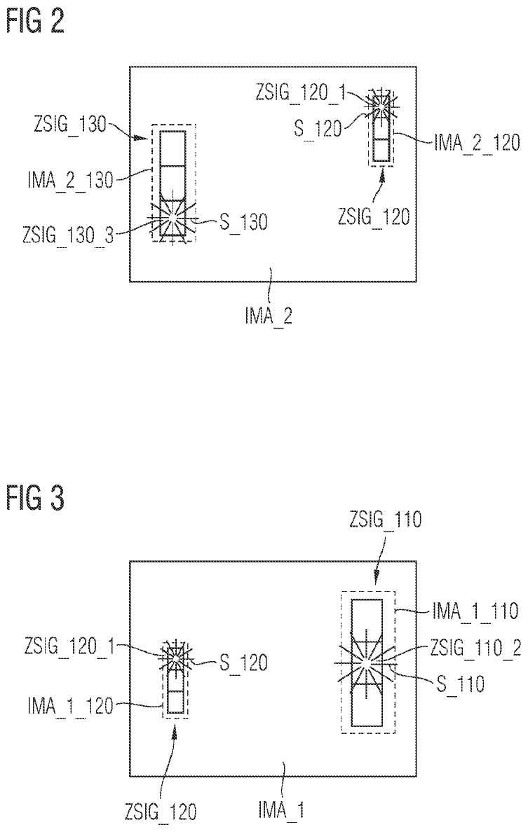

FIG. 2 shows an image IMA_2 captured by the camera KAM_2 by way of example and schematically. Said image shows the two state signal transmitters ZSIG_120, ZSIG_130 and the signals S_120, S_130 currently transmitted thereby. State signal transmitter ZSIG_110 is concealed by the wall W, and so the signal S_110 of said state signal transmitter is not depicted in the image IMA_2. It has been assumed for FIG. 2 that the corresponding components 120, 130 are in different operating states STAT_120, STAT_130. Accordingly, the green signal element ZSIG_120_1 is activated in the case of the state signal transmitter ZSIG_120, and so the signal S_120 transmitted by the state signal transmitter ZSIG_120 essentially consists of green light. Accordingly, the image IMA_2 shows a green region in the section IMA_2_120 corresponding to the state signal transmitter ZSIG_120. In the case of the state signal transmitter ZSIG_130, on the other hand, the red signal element ZSIG_130_3 is activated, and so the signal S_130 transmitted by the state signal transmitter ZSIG_130 essentially consists of red light.

Accordingly, the image IMA_2 shows a red region in the section IMA_2_130 corresponding to the state signal transmitter ZSIG_130. The analysis subsystem 142 is configured to use appropriate image processing in the image IMA_2 to detect colors in the sections IMA_2_120, IMA_2_130 of the image IMA_2 that correspond to the state signal transmitters ZSIG_120, ZSIG_130. Depending on the result of this detection, the analysis subsystem 142 infers the operating states STAT_120, STAT_130 of the corresponding components 120, 130. The analysis result for said signals S_120, S_130 would thus involve the component 120, for which a green signal S_120 has been determined, being in the state STAT_120=“normal state”. By contrast, the component 130, for which a red signal S_130 has been determined, is in the state STAT_130=“fault state”.

FIG. 3 shows an image IMA_1 captured by the camera KAM_1 by way of example and schematically. Said image shows the two state signal transmitters ZSIG_110, ZSIG_120 and the signals S_110, S_120 currently transmitted thereby. In this case, the state signal transmitter ZSIG_130 is concealed by the wall W. It has also been assumed for FIG. 3 that the corresponding components 110, 120 are in different operating states STAT_110, STAT_120. Accordingly, the amber signal element ZSIG_110_2 is activated for the state signal transmitter ZSIG_110, and so the signal S_110 transmitted by the state signal transmitter ZSIG_110 essentially consists of amber light.

Accordingly, the image IMA_1 shows an amber region in the section IMA_1_110 that corresponds to the state signal transmitter ZSIG_110. In the case of the state signal transmitter ZSIG_120, on the other hand, as in FIG. 2 and IMA_2, the green signal element ZSIG_120_1 is activated, and so the signal S_120 transmitted by the state signal transmitter ZSIG_120 essentially consists of green light. Accordingly, the image IMA_1 shows a green region in the section IMA_1_120 that corresponds to the state signal transmitter ZSIG_120.

The analysis subsystem 142 is configured to also use appropriate image processing in the image IMA_1 to detect colors in the sections IMA_1_110, IMA_1_120 that correspond to the state signal transmitters ZSIG_110, SIG_120. Depending on the result of this detection, the analysis subsystem 142 infers the operating states STAT_110, STAT_120 of the components 110, 120. The analysis result for said signals S_110, S_120 would thus involve the component 110, for which an amber signal S_110 has been determined, being in the state STAT_110=“warning”. By contrast, the component 120, for which a green signal S_120 has been determined, as already on the basis of the image IMA_2, is in the state STAT_120=“normal state”.

In the first design described in connection with FIG. 1-3, different operating states STAT_i of a component i are signaled by virtue of a respective state signal transmitter ZSIG_i transmitting optical signals S_i with different colors or in different spectral ranges or with different wavelengths. In other words and in more general terms, different operating states STAT_i are represented by signals S_i that have certain signal parameters SIGPARA1, SIGPARA2, . . . .

The signal parameters SIGPARAp with p=1, 2, . . . considered may be, for example, wavelength or color, signal intensity, pulse repetition rate, etc. In order to express different operating states, at least one of these signal parameters SIGPARA is varied and, depending on the operating state to be conveyed, differently adjusted. In the first design, this variable signal parameter SIGPARAp is thus the wavelength or the spectral range or the color of the light signal S_i transmitted by the state signal transmitter ZSIG_i. The variation of the signal parameter SIGPARAp=“wavelength” is manifested in different colors of the transmitted light S_i and signifies different operating states, as described above.

In a second design, the state signal transmitters ZSIG_i may be designed such that they transmit a pulsed optical signal S_i or, in other words, that they can flash. Different operating states STAT_i are signaled by different flash rates or pulse repetition rates. The signal parameter SIGPARAp to be varied here is thus the pulse repetition rate Pf or the pulse frequency, i.e. SIGPARAp=Pf, and different operating states are signaled by way of different values x_i of the pulse repetition rate Pf. In a simple case, in which only two operating states STAT_1, STAT_2 are intended to be distinguished, the applicable state signal transmitter ZSIG_i may be configured such that it reproduces the state STAT_1 with a signal pulsed at an arbitrary pulse repetition rate Pf1>0 Hz and the state STAT 2 with a continuous signal, i.e. with a pulse repetition rate Pf2=0 Hz. In such a design, in which the change in the signal S_i over time can be analyzed, there is the possibility of the cameras producing dynamic images or videos IMA_k, as mentioned above.

In some embodiments, the state signal transmitters ZSIG_i to be designed such that they have a multiplicity of individual light sources of identical color, for example white, that are arranged above and/or beside one another, for example in the form of a matrix. The variable signal parameter SIGPARA used in this case is which of the individual light sources is or are activated, i.e. the variable signal parameter is the identity of the active light sources of the state signal transmitter ZSIG_i. Different states of the state signal transmitter ZSIG_i are expressed by different individual light sources being activated.

Consequently, different values x of this signal parameter are expressed in the captured image IMA_k by an optical signal being depicted at different locations in the image IMA_k or in the section IMA_k_i that corresponds to this state signal transmitter ZSIG_i. In this case, the analysis subsystem 142 is configured to use appropriate image processing in the sections IMA_k_i in the image IMA_k that correspond to such a state signal transmitter ZSIG_i to detect the location in such a section IMA_k_i at which an optical signal is depicted. Depending on the result of this detection, the analysis subsystem 142 infers the operating states STAT_i of the corresponding component i.

In principle, there may be provision for different types of state signal transmitters ZSIG_i to be used in the industrial installation, i.e. for example firstly those state signal transmitters ZSIG_i that communicate different states STAT_i with signals S_i of different wavelengths, secondly those state signal transmitters ZSIG_i that communicate different states STAT_i with pulsed signals S_i having different pulse repetition rates Pf, and/or furthermore those state signal transmitters ZSIG_i that indicate different states STAT_i by way of different activated individual light sources. As indicated above, other approaches or other types of state signal transmitters are also conceivable in order to communicate different operating states STAT_i by way of signals S_i that are characterized by differing values x_i of determined signal parameters SIGPARA.

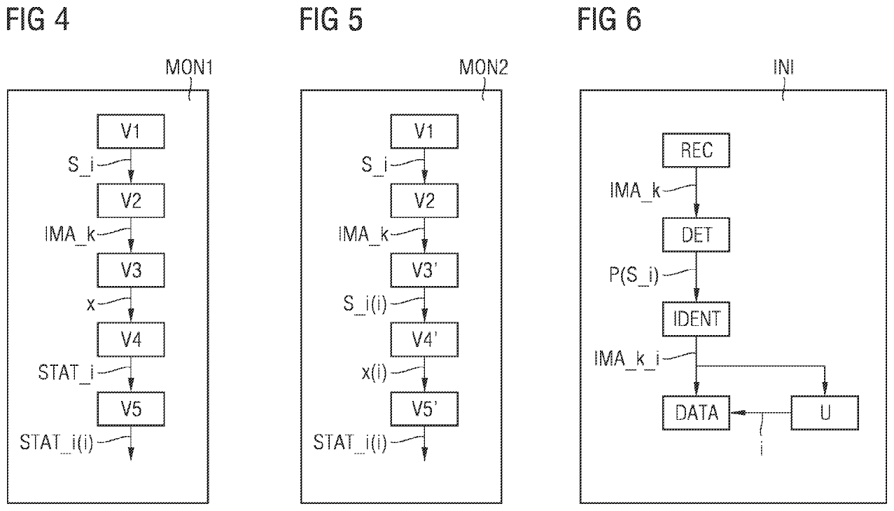

To summarize and generalize the above, a first method step V1 of a first variant MON1 of the mentioned monitoring method shown in FIG. 4 thus comprises a respective state signal transmitter ZSIG_1 transmitting a signal S_i that represents the operating state STAT_i of the component i associated with the signal transmitter ZSIG_i.

A second method step V2 comprises depicting the respective signal S_i using the at least one camera KAM_k in an image IMA_k, so that at least the signal S_i is discernible in the image IMA_k.

A third method step V3 comprises the analysis subsystem 142 analyzing the image IMA_k so that the value x_i of a predefined signal parameter SIGPARA of the signal S_i is determined, the signal parameter SIGPARA in the example illustrated above being the color or the wavelength or the spectral range of the signal S_i, and possible values x_i being x_i=“green”, x_i=“amber”, x_i=“red”, for example. Other signal parameters SIGPARA are conceivable, for example a pulse repetition rate Pf.

A fourth method step V4 comprises determining the operating state STAT_i that corresponds to the determined value x_i of the signal parameter SIGPARA, for example on the basis of an appropriate database DAT in which the possible values x_i are unambiguously associated with the possible operating states STAT_i or ZSTAT_i.

A fifth method step V5 comprises associating the thus determined operating state STAT_i with the component i of the industrial installation 100, symbolized by STAT_i(i) in FIG. 4.

The unambiguous association of the determined states STAT_i with the different components i is readily possible because, following installation of the cameras KAM_k in the industrial installation 100, neither the positions, orientations and configurations of the cameras KAM_k nor those of the components i are altered. Accordingly, a section IMA_k_i of an image IMA_k always shows the same state signal transmitter ZSIG_i or the signal S_i thereof. Accordingly, following installation of the cameras KAM_k, the analysis subsystem 142 need only once store which section IMA_k_i in the respective image IMA_k corresponds to which state signal transmitter ZSIG_i, which means that it is also immediately specified which component i is affected. This information is used to always automatically associate a detected signal S_i with the correct component i.

On the basis of this, the cameras KAM_k could, in principle, be configured such that the components i and/or the state signal transmitters ZSIG_i themselves are not discernible in the images IMA_k and that only the signals S_i are visible, since the position of the depiction of the respective signal S_i in a specific section IMA_k_i of the image IMA_k can readily be used to infer the state signal transmitter ZSIG_i and therefore the component i from which the signal S_i originates. This configuration of the cameras KAM_k concentrating only on the possible signals S_i permits greater accuracy for the analysis and greater utilization of the bandwidth of the conceivable signals S_i insofar as two different signals can have their wavelengths closer together and still be distinguishable.

In some embodiments, MON2 of the monitoring method shown in FIG. 5, the order of steps V3-V5 can be altered while method steps V1, V2 remain the same. In this alternative, the third method step V3′ initially comprises associating the signal S_i in the image IMA_k with the corresponding component i of the industrial installation 100, this too drawing on the fact that, as described above, sections IMA_k_i in the respective image IMA_k and state signal transmitters ZSIG_i and therefore components i can be unambiguously associated with one another. This association of the signal S_i with the component i is symbolized by S_i(i) in FIG. 5. A fourth method step V4′ of the alternative variant comprises each signal S_i(i) being analyzed for each component i by the analysis subsystem 142 to determine the value x_i of a signal parameter of the signal S_i(i), for example the color, resulting in values x_i(i) for each component i.

A fifth method step V5′ of the alternative variant comprises determining for each signal S_i(i) the operating state STAT_i(i) corresponding to the determined value x_i(i) of the signal parameter of the signal S_i(i), for example on the basis of the aforementioned database DAT in which the possible values x_i are unambiguously associated with the possible operating states. This thus determined operating state STAT_i(i) is directly associated with the corresponding component i, since the signal S_i has already been associated with the component i in step V3′.

The accordingly summarized monitoring method with steps V1-V5 in the first variant and also the alternative variant with steps V1, V2, V3′-V5′ eventuate in an analysis result, in particular comprising the operating states STAT_i=ZSTAT_i of the components i.

The cameras KAM_k may be configured to produce dynamic images IMA_k, i.e. videos. In this case, the images IMA_k are continuously analyzed by the analysis subsystem 142 in the monitoring method with regard to the signals S_i that are visible in the videos IMA_k, the analysis being no different than the procedure described above. Alternatively, the cameras KAM_k are configured such that the images IMA_k are static images. In this case, either the supervisory system 140 acts such that each camera KAM_k, at predefined intervals of time, automatically produces images IMA_k that are subsequently analyzed as described above, or the cameras KAM_k produce a respective static image IMA_k, subsequently analyzed as described above, only when this is initiated by a user by way of appropriate manual input.

The analysis subsystem 142, which, as mentioned, may be realized as a computer-incremented method, for example as software on the control computer 143, is configured to perform the analysis method comprising method steps V1-V5 or V1, V2, V3′-V5′ and thus to determine the analysis result comprising the operating states STAT_i of the components i. These analysis results can be presented on a screen or the like and stored as required, in order to build up a history of the operating states of the industrial installation 100.

Furthermore, the analysis subsystem 142 may be configured such that it permits an automatic or semiautomatic initialization INI comprising individual steps REC, DET, IDENT, DATA. This is shown schematically in FIG. 6. The initialization should be performed after installation of the cameras KAM_k, for example in the event of a reinstallation of the supervisory system 140 with the recording subsystem 141 and the analysis subsystem 142 in an industrial installation 100 that is already equipped with state signal transmitters ZSIG_i. A repeat performance of the initialization INI may furthermore be useful in order to react to any alterations in the industrial installation 100, as explained below.

The initialization INI comprises a recording step REC, in which the cameras KAM_k are each used to capture at least one image IMA_k in which the signals S_i of the state signal transmitters ZSIG_i are visible. The initialization INI further includes, in a detection step DET, initially detecting the signals S_i in the respective image IMA_k, it still being unimportant in the initialization INI what value a respective signal parameter has, but rather the position P(S_i) of the depiction of the respective signal S_i in the image IMA_k being determined. Based on the positions P(S_i), an identification step IDENT comprises specifying the sections IMA_k_i in the respective image IMA_k that correspond to the state signal transmitters ZSIG_i and therefore the components i.

This involves initially identifying which image pixels from IMA_k belong to a respective section IMA_k_i. Depending on the aspect of the applicable state signal transmitter ZSIG_i, these image pixels are situated in the environs of the position P(S_i) of the depiction of the signal S_i in the respective image IMA_k. The sections IMA_k_i can be identified on the basis of an artificial intelligence implemented in the analysis subsystem 142. This artificial intelligence has been trained in advance so that it has learnt to use camera images KAM_k depicting signals S_i from state signal transmitters ZSIG_i to be able to identify where which section IMA_k_i is in an image IMA_k, i.e. which pixels of the image IMA_k are related to the section IMA_k_i.

In some embodiments, the sections IMA_k_i can be identified manually by virtue of a user visually identifying and subsequently specifying in the respective image IMA_k where which section IMA_k_i is situated, i.e. which pixels are related, for example by arranging a frame in the respective image IMA_k at the location of the respective section IMA_k_i, which frame surrounds the related pixels. Following identification of the sections IMA_k_i, the initialization INI is concluded in a step DATA by recording the component i to which the respective section IMA_k_i corresponds in the database DAT. This can be accomplished for example by way of a manual input from a user U who knows which state signal transmitter ZSIG_i is visible in a respective section IMA_k_i. This information can be used to associate the section IMA_k_i with the component i in the database DAT.

In some embodiments, instead to manual input by a user U, it is also possible at this juncture for i and IMA_k_i to be associated automatically, the role of the user U thus being performed by an automatic system U. This is possible for example when the analysis subsystem 142 performing the initialization knows the setup of the industrial installation 100 and the positioning, orientation and configuration of the cameras KAM_k. This information can readily be used to derive or calculate the sections IMA_k_i of a respective image IMA_k in which the state signal transmitters ZSIG_i must be depicted, meaning that the component i and the section IMA_k_i can be associated automatically for the database DAT. This process of automatically associating the component i and the section IMA_k_i can furthermore be performed by an artificial intelligence, which for example can take image backgrounds, setup of the industrial installation 100 and/or other information in the image IMA_k to decide on the component i to which the section IMA_k_i must correspond.

The initialization INI may, as an alternative or in addition to initialization on reinstallation, also take place every single time the industrial installation 100 is started up, for example even if the industrial installation 100 resumes normal operation following a maintenance phase or standby. Furthermore, the initialization INI can take place following appropriate manual initiation by a user.

Further, the analysis subsystem 142 may be designed such that an initialization INI such as this is performed regularly. As mentioned, the monitoring method may proceed such that the cameras KAM_k automatically produce static images IMA_k at prescribed intervals of time dTIMA. Regular initialization can likewise be performed at predefined intervals of time dTINI, with dTINI being chosen, according to need and depending on dTIMA, to be much greater than dTIMA, for example daily or weekly and for example depending on when alterations to the industrial installation 100 can be expected. This automatic and regular performance of the initialization INI can ensure that if a component i′ having a state signal transmitter ZSIG_i′ has been added or else removed or has failed, it is detected that the industrial installation 100 has accordingly been altered.

In the first scenario of a component i′ being added or reactivated, it is therefore possible to automatically match the analysis subsystem 142 and therefore the supervisory system 140 to the new scenario. The initialization INI results in the database DAT being used to also store the sections IMA_k_i′ of the added component i′ for each image IMA_k. As explained above, the association may require manual intervention by a user U, since the system does not necessarily know which component i′ has been added. The fact that an addition has taken place is detected automatically, however, and in such a case the user U can be notified thereof by appropriate signaling on an output device of the supervisory system 140, meaning that they are able to perform the possibly manual input for the database DAT.

The second scenario of an originally present component i of the industrial installation 100 being removed or absent, resulting in the corresponding signal S_i being absent from the images IMA_k of the step REC, can arise if the component i has actually been physically removed, if it has been shut down, if it has failed entirely, including the associated state signal transmitter ZSIG_i, or else if only the state signal transmitter ZSIG_i has failed. In this second scenario, a prompt to the user U can be initiated, said prompt firstly being used to advise the user U of the absence of the signal S_i, and the user subsequently needing to acknowledge said prompt with an appropriate input. If the component i in question has actually been removed or shut down, the corresponding entry in the database DAT can be deleted.

To summarize, the repeat performance of the initialization INI comprising the steps REC, DET, IDENT, DATA thus results in the analysis subsystem 142 being able to detect both the addition of components i′ and the absence of previously present components i, in each case based on a signal S_i′ being added or a signal S_i being absent in a respective image IMA_k.

A memory MEM of the control computer 143, which may also store the database DAT, can be used to store the respective operating states STAT_i determined over time for the components i, meaning that the history of the operating state of a respective component i can be tracked.

In the explanations above, it has been assumed that the signals S_i are optical signals, at least one of whose signal parameters SIGPARA, for example their color or a pulse repetition rate of a flashing signal, differs for different operating states ZSIG_i of the component i. From an abstract perspective, the images IMA_k are representations of the signals S_i recorded in each case by a camera KAM_k. The solution described is not fundamentally limited to optical or electromagnetic signals S_i, however. In general, it is also possible to use acoustic signals S_i, for example, the wavelength of which, for example, can be varied in order to signal different operating states ZSIG_i.

These wavelengths may be in an inaudible range, so that personnel in the industrial installation 100 are not disturbed or impaired. Consequently, the recording units KAM_k in this case are not in the form of cameras, but rather in the form of microphones. Association of a signal S_i with a specific component i can be achieved as a result of the microphones having a directional characteristic. In some embodiments, in addition to the variation that is dependent on the operating state, the signals S_i may be modulated on the basis of the component i. That is to say that the modulation of the signal S_i identifies the component i and the value of the signal parameter to be varied signals the operating state of the component i. In abstract terms, in this aspect with acoustic signals S_i too, the microphones KAM_k are used to record the signals S_i in order to produce a representation IMA_k of the signals S_i that can then be taken as a basis for determining the values x_i of the signal parameters SIGPARA of the signal S_i.

The solution described advantageously makes provision for it to be able to be used to upgrade installations already equipped with state signal transmitters ZSIG_i without intervention in the existing system. Such a retrofit system comprises the recording subsystem 141, containing the recording units KAM_k, and the analysis subsystem 142. To upgrade an industrial installation containing existing state signal transmitters ZSIG_i, the recording units KAM_k are positioned in the industrial installation such that each recording unit KAM_k records at least one state signal transmitter ZSIG_i. The aim of the number of recording units KAM_k and the positioning, orientation and configuration thereof, in the case of cameras in particular with regard to the optical properties, is to depict the signals S_i of all relevant state signal transmitters ZSIG_i, i.e. every such signal S_i is depicted in at least one representation IMA_k, or in at least one image IMA_k.

This solution, whether retrofitted or even installed at the time of the industrial installation being set up, now permits the operating states of the machines of the industrial installation to be automatically detected and passed on to the supervisory system of the installation. This affords various advantages, from significantly lower effort for state inventory of the machines to substantially reduced reaction time when a fault occurs.

### REFERENCE SIGNS

100 industrial installation
140 supervisory system
141 recording subsystem
142 analysis subsystem
143 control computer
i machine (i=110,120,130)
DAT database
DATA method step
DET detection step
FoV_k recording range, field of view (k=1, 2)
ID_i identification (i=110,120,130)
IDENT identification step
IF_i interface (i=110,120,130)
IMA_k_image (k=1, 2)
IMA_k_i image section (i=110,120,130; k=1, 2)
INI initialization
KAM_k recording unit, camera (k=1, 2)
REC recording step
S_i signal (i=110,120,130)
SIGPARA signal parameter
SR_i open-loop/closed-loop control unit (i=110,120,130)
STAT_i operating state (i=110,120,130)
UM surroundings
V1, V2, V3, V3′, V4, V4′, V5, V5′ method step
ZSIG_i state signal transmitter (i=110,120,130)
ZSIG_i_j optical signal element (i=110,120,130; j=1, 2, 3)
ZSTAT_i state (i=110,120,130)
U user, system

What is claimed is:

1. system for monitoring states ZSTAT_i of a number NSIG≥1 of state signal transmitters ZSIG_1 with i=1, . . . , NSIG of one or more components in surroundings of an installation, a respective state signal transmitter ZSIG_i configured to transmit a signal S_i that unambiguously represents its current state ZSTAT_i, the system comprising:
a recording subsystem comprises a number NERF≥1 of recording units KAM_k with k=1, . . . , NKAM, a respective recording unit KAM_k configured to record the transmitted signals S_i; and
an analysis subsystem configured to automatically use the signals S_i thus captured to derive current states ZSTAT_i of the respective state signal transmitters ZSIG_i.

2. The system as claimed in claim 1, wherein:
the current state ZSTAT_i of a respective state signal transmitter ZSIG_i represents the current operating state STAT_i of a component i of the installation associated with the respective state signal transmitter ZSIG_i;
a respective state signal transmitter ZSIG_i configured to adjust a value x_i=f(STAT_i) of a predefined, variable signal parameter of the signal S_i that unambiguously represents its current state ZSTAT_i in accordance with the current state ZSTAT_i.

3. The system as claimed in claim 1, wherein the system is designed:
to produce a representation IMA_k of the signals S_i by recording the signals S_i; and
to determine in a respective representation IMA_k, for each signal S_i represented in said representation, a value x_i of a predefined, variable signal parameter SIGPARA of the respective signal S_i; and
to use the respective determined value x_i to derive the current state ZSTAT_i of the related state signal transmitter ZSIG_i.

4. The system as claimed in claim 1, wherein:
the signals S_i are electromagnetic signals;
the recording units KAM_k comprise cameras and the representations IMA_k produced by the cameras KAM_k are images IMA_k, a respective camera KAM_k to depict at least one of the signals S_i in a respective image IMA_k; and
the analysis subsystem is configured to perform an analysis method for a respective image IMA_k, the analysis method used to determine in a respective image IMA_k, for each signal S_i depicted in said image, a value x_i of a predefined, variable signal parameter SIGPARA of the respective identified signal S_i and to use the respective determined value x_i to derive the current state ZSTAT_i of the related state signal transmitter ZSIG_i.

5. The system as claimed in claim 4, wherein the image IMA_k comprises a dynamic image.

6. The system as claimed in claim 4, wherein:
the image IMA_k comprises a static image;
the system is configured
to produce a multiplicity of static images IMA_k at predefined intervals of time dTIMA or
to produce a respective static image IMA_k when so required by a user, and
to perform the analysis method for a respective static image IMA_k produced.

7. The system as claimed in claim 4, wherein the analysis subsystem is configured to use a position P(S_i) of a depiction of the respective signal S_i in the respective image IMA_k to identify the state signal transmitter ZSIG_i related to the signal S_i and to unambiguously associate a respective derived state ZSTAT_i with the related state signal transmitter ZSIG_i thus identified.

8. The system as claimed in claim 1, wherein the system is configured to perform an initialization method INI including:
using a respective camera KAM_k to capture at least one image IMA_k that depicts, for each state signal transmitter situated in the recording range FoV_k of the camera KAM_k, the signal S_i delivered by this state signal transmitter ZSIG_i;
detecting in a respective captured image IMA_k the positions P(S_i) of the depictions of the signals S_i that are thus generated in the image IMA_k;
taking the detected positions P(S_i) as a basis for specifying sections IMA_k_i in the respective image IMA_k that correspond to the state signal transmitters ZSIG_i; and
recording the state signal transmitter ZSIG_i to which the respective section IMA_k_i corresponds in a database DAT.

9. The system as claimed in claim 1, wherein the system comprises a retrofit system for the installation.

10. A method for monitoring states ZSTAT_i of a number NSIG≥1 of state signal transmitters ZSIG_1 with i=1, . . . , NSIG of one or more components in surroundings UM of an installation, a respective state signal transmitter ZSIG_i being configured to transmit a signal S_i that unambiguously represents its current state ZSTAT_i, the method comprising:
recording the transmitted signals S_i using recording units KAM_k with k=1, . . . , NKAM of a recording subsystem; and
automatically deriving the current states ZSTAT_i of the respective state signal transmitters ZSIG_i from the recorded signals S_i.

11. The method as claimed in claim 10, further comprising:
producing a respective representation IMA_k of the signals S_i by recording the signals S_i by means of the recording units KAM_k;
determining, in a respective representation IMA_k, for each signal S_i represented in said representation, a value x_i of a predefined, variable signal parameter SIGPARA of the respective signal S_i; and
using the respective determined value x_i to derive the current state ZSTAT_i of the related state signal transmitter ZSIG_i.

12. The method as claimed in claim 10, wherein:
the signals S_i comprise electromagnetic signals,
the representations IMA_k of the signals S_i are images IMA_k in which the signals S_i are depicted in corresponding regions of the respective image IMA_k,
an analysis method comprising:
determining in a respective image IMA_k, for each signal S_i depicted in said image, a value x_i of a predefined, variable signal parameter SIGPARA of the respective identified signal S_i and
using the respective determined value x_i to derive the current state ZSTAT_i of the related state signal transmitter ZSIG_i.

13. The method as claimed in claim 10, wherein a position P(S_i) of a depiction of the respective signal S_i in the respective image IMA_k is used to identify the state signal transmitter ZSIG_i related to the signal S_i and to unambiguously associate a respective derived state ZSTAT_i with the related state signal transmitter ZSIG_i thus identified.

14. The method as claimed in claim 13, wherein the state signal transmitter ZSIG_i related to the signal S_i is identified by establishing which section IMA_k_i from previously specified sections IMA_k_i of the image IMA_k contains the depiction of the signal S_i, wherein a database DAT stores the state signal transmitter ZSIG_i to which a respective section IMA_k_i corresponds.

15. The method as claimed in claim 10, wherein in an initialization method INI, in particular prior to the states ZSTAT_i being monitored, the method comprising:
using a respective camera KAM_k to capture at least one image IMA_k that depicts, for each state signal transmitter situated in the recording range FoV_k of the camera KAM_k, the signal S_i delivered by this state signal transmitter ZSIG_i;
detecting in a respective captured image IMA_k the positions P(S_i) of the depictions of the signals S_i that are thus generated in the image IMA_k;
taking the detected positions P(S_i) as a basis for specifying sections IMA_k_i in the respective image IMA_k that correspond to the state signal transmitters ZSIG_i; and
recording the state signal transmitter ZSIG_i to which the respective section IMA_k_i corresponds in a database DAT.
